(19) United States
(12) Patent Application Publication
(10) Pub. No.: US 2026/0319146 A1
(43) Pub. Date: Oct. 15, 2026

(54) OPTICAL LENS SYSTEMS AND IMAGING SYSTEMS INCORPORATING THE SAME

(71) Applicant: NIL Technology ApS, Kongens Lyngby (DK)

(72) Inventors: Fredrik Mattinson, Stockholm (SE); Olivier Francois, Copenhagen (DK); Ulrich Quaade, Copenhagen (DK); Ehsan Hashemi, Stockholm (DK)

(21) Appl. No.: 19/104,556

(22) PCT Filed: Aug. 17, 2023
(86) PCT No.: PCT/EP2023/072751

§ 371 Date: Feb. 18, 2025

Related U.S. Application Data
(60) Provisional application No. 63/399,347, filed on Aug. 19, 2022.
(60) Provisional application No. 63/421,037, filed on Oct. 31, 2022.

(51) Int. Cl. G02B 5/18

(52) U.S. Cl. CPC G02B 5/1814

(57) ABSTRACT

An example apparatus includes a lens system. The lens system includes a first lens group, a second lens group, and an aperture stop layer disposed between the first and second lens groups. Each of the first and second lens groups includes at least one respective lens, and at least one of the first or second lens groups includes at least one of a meta optical element (MOE) lens or a diffractive optical element (DOE) lens. The disclosure also describes receiving and projecting imaging systems including the lens system, as well as associated methods.

### FIELD OF THE DISCLOSURE

The present disclosure relates to optical lens systems and imaging systems incorporating an optical lens system.

### BACKGROUND

Some lenses, such as meta optical elements (MOEs) and diffractive optical elements (DOEs), employ a flat optic technology. MOEs, for example, have a metasurface that includes distributed small subwavelength structures (e.g., nanostructures or other meta-atoms) arranged to interact with light in a particular manner. The meta-atoms can, individually and/or collectively, interact with light waves to change a local amplitude, a local phase, or both, of an incoming light wave. Likewise, DOEs have microstructure patterns that alter and control the phase of an incoming light wave. By altering the microstructures, it is possible for a DOE to produce a range of beam intensity profiles or beam shapes. MOEs or DOEs can be used, for example, in optical applications to take advantage of the flat surface and reduced thickness, compared to classic, curved refractive lenses.

Flat optical lenses such as MOEs and DOEs, however, tend to suffer from large chromatic dispersion because the diffraction phenomenon is highly wavelength-dependent. If such chromatic dispersion is not addressed, an imaging system that incorporates such optical elements may have large chromatic aberrations which leads to more limited (i.e., narrow) operational spectral bandwidth (e.g., of only a few nanometers). Such constraints can place harsh limitations on the choice of light sources for scene illumination and may limit the overall efficiency of these imaging systems.

### SUMMARY

The present disclosure describes optical lens systems and imaging systems incorporating an optical lens system, as well as associated methods.

For example, in one aspect, the present disclosure describes an apparatus including a lens system. The lens system includes a first group of lens, a second group of lens, and an aperture stop disposed between the first and second groups of lenses. Each of the first and second group of lenses includes at least one respective lens, and at least one of the first or second group of lenses includes at least one of a meta optical element (MOE) lens or a diffractive optical element (DOE) lens.

Some implementations include one or more of the following features. For example, in some implementations, each of the first and second lens groups includes at least one of an MOE lens or a DOE lens. In some implementations, each of the first and second lens groups includes a respective MOE lens. In some cases, each of the MOE lenses includes a respective metasurface on a respective substrate, and a respective gap is present between the aperture stop and each of the substrates. In some cases, each of the MOE lenses includes a respective metasurface on a respective substrate, and there is a gap between the aperture stop and at least one of the substrates. In some cases, each of the MOE lenses includes a respective metasurface on a respective substrate, and respective backsides of the substrates are attached to another. In some implementations, each of the first and second lens groups includes a respective DOE lens.

In some implementations, at least one of the first lens group or the second lens group includes a plurality of lenses. A total power of the first lens group can be the same as, or different from, a total power of the second lens group, depending on the application. Further, in some instances, for example, lateral chromatic aberration of the lens system is smaller than ten times an Airy disk radius for the lens system.

In the some implementations, the apparatus further includes one or more image sensors disposed to capture an image of an object based on light emitted by, or reflected from, the object and passing through the lens system. In some cases, the second lens group is closer to the one or more image sensors than is the first lens group, and an equivalent power of the second lens group is greater than 25% of an equivalent power of the first lens group. In some cases, the second lens group is closer to the one or more image sensors than is the first lens group, and a converging power of the second lens group is greater than 25% of a converging power of the first lens group. In some implementations, the image sensor has one or more pixel pitches, and lateral chromatic aberration of the lens system is less than ten times the largest pixel pitch. In some cases, lateral chromatic aberration of the lens system is less than (10 μm).

The present disclosure also describes receiving and projecting imaging systems. For example, an imaging system can include one or more image sensors disposed to capture an image of an object based on light emitted or reflected from the object and passing through the lens system. Likewise, a light projection system can includes a light emitting or reflecting device that emits or reflects lights into the lens system.

The present disclosure also describes a method that includes receiving, in a lens system, light emitted by or reflected from an object. The lens system includes a first lens group, a second lens group, and an aperture stop disposed between the first and second lens groups, wherein each of the first and second lens groups includes at least one respective lens, and wherein at least one of the first or second lens groups includes at least one of a meta optical element (MOE) lens or a diffractive optical element (DOE) lens. The method further includes capturing an image of the object in one or more images sensor based on the light reflected from the object, the light having subsequently passed through the first lens group, the aperture stop, and the second lens group before impinging on the one or more image sensors.

Some implementations include one or more of the following features. For example, in some implementations, the light emitted or reflected from the object passes through the first lens group before passing through the second lens group, and a total power of the first lens group is smaller than a total power of the second lens group. In some implementations, each of the first and second lens groups includes a respective MOE lens, and the light reflected from the object passes through the first MOE lens before passing through the second MOE lens.

In a further aspect, the present disclosure describes a method that includes projecting, in a lens system, light emitted by or reflected from a light emitting or reflecting device. The lens system includes a first lens group, a second lens group, and an aperture stop disposed between the first and second lens groups, wherein each of the first and second lens groups includes at least one respective lens, and wherein at least one of the first or second lens groups includes at least one of a meta optical element (MOE) lens or a diffractive optical element (DOE) lens.

Some implementations include one or more of the following features. For example, in some implementations, the light emitted by or reflected from the light emitting or reflecting device passes through the first lens group before passing through the second lens group, and an equivalent power of the first lens group is larger than an equivalent power of the second lens group. In some cases, each of the first and second lens groups includes a respective MOE lens, and the light emitted by or reflected from the light emitting or reflecting device passes through the MOE lens of the first lens group before passing through the MOE lens of the second lens group.

In some implementations, the lens systems described in this disclosure can improve the performance of flat optical lenses by reducing the lateral chromatic aberrations in an imaging system. Such improvements can help enhance the operational spectral bandwidth of the system and make the system compatible with the bandwidth of standard light sources such as vertical cavity surface emitting lasers (VCSELs) and light emitting diodes (LEDs). In addition to reducing the lateral chromatic aberration, in some implementations, the lens systems can correct other types of monochromatic geometrical aberrations such as coma and distortion, thereby further enhancing the overall performance, quality, and/or efficiency of the imaging system. In some instances, the lens arrangements can enhance the field of view (FOV), F-number (F/#), and/or compactness (e.g., a smaller optical track length) of the imaging systems.

The lens systems described in this disclosure can be integrated, for example, into MOE- or DOE-based receiver or transmitter optics. MOE-based lens systems, for example, can, in some implementations, make use of standard design and manufacturing methods for the nanostructures without trading off the very high focusing efficiency (>90%) and diameter size (>1 mm) of the established library of meta-atoms and the design principles of the entirety of the nanostructures in the metasurface. Further, the lens systems described in the present disclosure can be particularly advantageous for use with relatively high-resolution image sensors, where lateral chromatic aberration may otherwise be problematic. The lens systems described here also can be incorporated in other types of optical devices (e.g., gratings) and systems.

Other aspects, features, and advantages will be readily apparent from the following detailed description, the accompanying drawings, and the claims.

### BRIEF DESCRIPTION OF THE DRAWINGS

FIG. 1 illustrates an example of an imaging system including a lens system.

FIG. 2 illustrates another example of an imaging system including a lens system.

FIG. 3A illustrates an example of chief optical rays at three distinct wavelengths passing through an imaging system.

FIGS. 3B through 3E illustrates enlarged versions of portions of FIG. 3A, which shows a significant reduction in lateral color aberrations.

FIG. 4 illustrates yet another example of an imaging system including a lens system.

FIG. 5 illustrates a further example of an imaging system including a lens system.

FIG. 6 illustrates yet another example of an imaging system including a lens system.

### DETAILED DESCRIPTION

The optical materials of lenses generally have a degree of wavelength dispersion because the refractive index of the lens material typically depends, at least slightly, on the wavelength of light propagating through a medium. This phenomenon is due to the dependence of the phase velocity of a wave on its frequency. An important consequence of dispersion is the change in the angle of refraction depending on the light wavelength. Diffraction based flat optics such as MOEs and DOEs introduce significantly larger dispersions due to the wavelength dependency. These dispersion effects impact the image formation quality and introduce large chromatic aberrations. Chromatic aberration can be divided into longitudinal (axial) direction or transverse (lateral) direction. The lateral chromatic aberration or lateral color is the lateral or transverse in-plane shift of the chief ray piercing the image plane due to chromatic aberration in the lens system. It can be defined as the change of lens system magnification factor by wavelength.

The axial chromatic aberration or axial color is the longitudinal/axial shift in marginal ray focus points along the optical axis and can be defined as the change of best focus point along optical axis for different wavelengths.

As described in greater detail below, a lens system includes at least two lens groups, with an aperture stop disposed between them. At least one of the lens groups includes a MOE or DOE lens. Placing the aperture stop between the lens groups can help compensate for lateral chromatic aberration introduced by one or more lenses in the system and balance out lateral color shifts. In some instances, by placing the aperture stop between lens groups having similar dispersion properties, the system can cancel out the rather large lateral color shift introduced by the lens group disposed before the aperture stop. Such systems can, in some cases, reduce the change of lens magnification by wavelength and, therefore, improve the image quality in the tangential direction for multi-wavelength lens systems. In some implementations, other transverse aberrations such as distortion and coma can be reduced as well.

The systems described here can be particularly advantageous for arrangements in which the lens groups on both sides of the aperture layer includes at least one respective MOE or DOE lens. Nevertheless, some arrangements include a MOE or DOE lens on only one side of the aperture layer. Either, or both, of the lens groups also may include other types of lenses (e.g., refractive lenses, graded index (GRIN) lenses, volume lenses, and/or surface holographic lens (HOEs)), or a combination of different types of lenses).

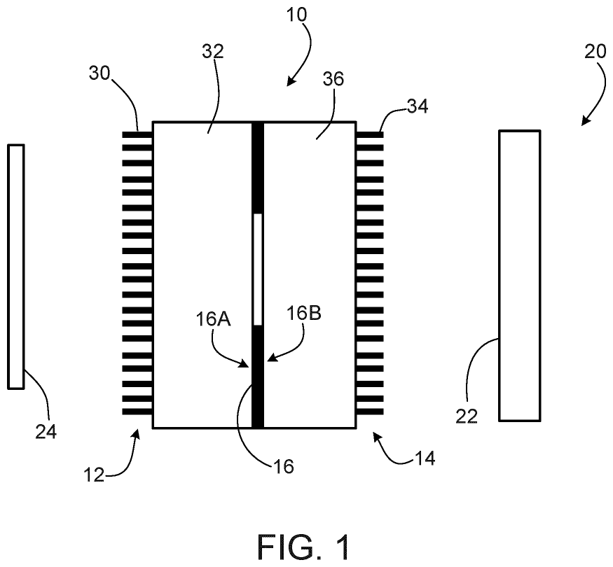

As shown in the example of FIG. 1, a lens system 10 includes an aperture stop 16, a first lens group disposed at a first side of the aperture stop 16, and a second lens group disposed at a second side of the aperture stop 16, where the second side is opposite that of the first side. The first lens group includes at least one first MOE (or DOE) lens 12, and the second lens group includes at least one second MOE (or DOE) lens 14. Each of the first and second lens groups may include one or more additional lenses.

In the illustrated example of FIG. 1, the first MOE (or DOE) lens 12 is disposed before the aperture stop 16 (i.e., closer to the front side 16A of the aperture stop), and the second MOE (or DOE) lens 14 is disposed after the aperture stop 16 (i.e., closer to the backside 16B of the aperture stop). Thus, for example, if the lens system 10 is integrated into an imaging system 20 (e.g., a camera) that includes a CMOS-based or other opto-electronic sensor 22 operable to capture an image of an object 24, the first MOE (or DOE) lens 12 can be closer to the object 24, and the second MOE (or DOE) lens 14 can be closer to the image plane of the sensor 22. In some implementations, instead of a single image sensor, there may multiple image sensors (e.g., an array of image sensors) arranged, collectively, to capture the image. Depending on the application, the one or more image sensors can be disposed to capture an image of an object based on light emitted by, or reflected from, the object and passing through the lens system.

As shown in FIG. 1, for implementations in which each of the first and second lens groups includes a respective MOE lens, the first MOE lens 12 can include a metasurface 30 disposed on an optically translucent or at least partially transparent substrate 32 (e.g., a glass, plastic or polymer material). Likewise, the second MOE lens 14 can include a metasurface 34 disposed on an optically translucent or at least partially transparent substrate 36 (e.g., a glass, plastic or polymer material). The substrates 32, 36 can provide mechanical support for the metasurfaces 30, 34.

As noted above, other optical surfaces, with or without refractive optical power, also may be present in some implementations to provide additional performance or functionality. In some implementations, the equivalent lens power of each respective lens group (whether composed of a single lens or multiple lenses) on either side of the aperture stop 16 is approximately the same. In some implementations, the equivalent lens power of the first and second lens groups may differ. For example, in some implementations, the equivalent lens power of the second lens group (i.e., the lens group closer to the image sensor 22) is stronger than the equivalent lens power of the first lens group (i.e., the lens or lenses closer to the object 24). That is, the group of one or more lenses facing the object 24 may have a weaker total power than the group of one or more lenses facing the sensor 22. In some cases, it is advantageous for the equivalent power (or converging power) of the second lens group facing the image sensor 22 to be greater than 25% of the equivalent power (or converging power) of the first lens group facing the object 24. Further, in some cases, the equivalent power (or converging) of the lens group facing the image sensor 22 is greater than 50% of the equivalent power (or converging power) of the lens group facing the object 24. In some cases, the equivalent power (or converging) of the lens group facing the image sensor 22 is greater than 75% of the equivalent power (or converging power) of the lens group facing the object 24.

On the other hand, in some implementations (e.g., optical projection systems that include a light emitting or reflecting device), the equivalent lens power of the first lens group (i.e., the lens group closer to the light source) may be stronger than the equivalent lens power of the second lens group. The light emitting or reflecting device may be, or include, for example, a display, a light engine, a digital micromirror device (DMD), a liquid crystal display (LCD), a liquid crystal technology on silicon (LCOS) projector or other spatial light modulator, a vertical cavity surface emitting laser (VCSEL) chip, or a light emitting diode (LED). Other types of light emitting or reflecting devices may be used in some implementations.

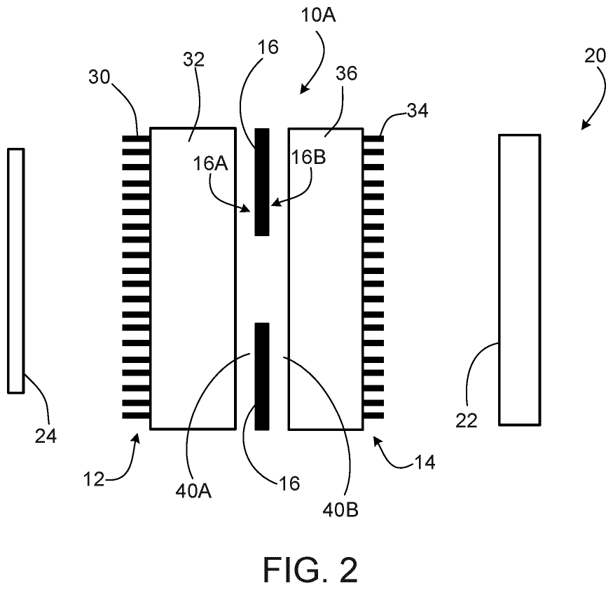

An aperture layer can function as the aperture stop 16 in the system to limit the solid angle of rays passing through the system from an on-axis object point, which defines the cone of light reaching the image plane of the sensor 22. In some implementations, the aperture layer 16 is composed of a hole (e.g., a circular opening) in a light blocking material such as black chrome layer disposed on one or both of the substrates 32, 36. In some instances, the first and second lenses 12, 14 are bonded, stacked, or otherwise attached, back-to-back to one another (i.e., without a gap between them), with the aperture layer 16 disposed between them. For example, in some cases, the substrates 32, 36 of the lenses 12, 14 can be bonded to one another by an optically clear adhesive. In some implementations, the aperture stop 16 is physically separated from one (or both) of the lenses 12, 14. That is, as shown in the example lens system 10A of FIG. 2, the aperture stop 16 can be separated from the lens substrates 32, 36 by respective air gaps 40A, 40B. In some instances, an air gap 40A (or 40B) is present between the aperture stop 16 and only one of the lens substrates 32 (or 36), and the aperture stop 16 is disposed on a surface of the other one of the lens substrates 36 (or 32).

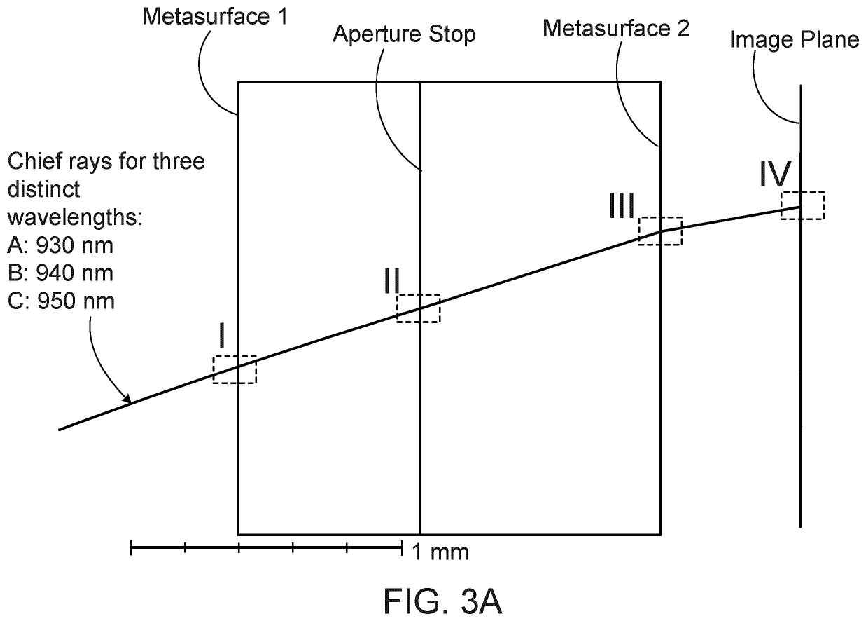

FIGS. 3A through 3E illustrate an example of chief optical rays at three distinct wavelengths (930 nm; 940 nm, 950 nm) passing through a first metasurface, then through an aperture stop, then through a second metasurface, and finally reaching an image plane. The lateral positions of the chief rays at the second metasurface (see FIG. D) are the opposite of the respective lateral positions at the first metasurface (see FIG. 3B). Such an arrangement can help cancel out or reduce the transverse aberrations and specifically the lateral color aberration at the image plane.

In some implementations, by providing an aperture stop between two lens groups, at least one of which includes a MOE or DOE lens, lateral chromatic aberration can be canceled out or reduced. A reduction in lateral chromatic aberration can be particularly advantageous, for example, in imaging systems that have a large field points such as wide FOV systems. In some instances, lateral chromatic aberration of the lens system is smaller than ten times (10×) an Airy disk radius for the lens system. In some instances, the lateral chromatic aberration of the lens system is smaller than twice (2×) the Airy disk radius for the lens system. Preferably, the lateral chromatic aberration is reduced to be smaller than the Airy disk radius (1×) for the lens system. Depending on the particular application, the operational wavelength for the lens system may be, for example, in the visible range (400-700 nm), the near-infrared range (700-1400 nm), the short-wavelength infrared range (1.4-3 um), or the mid-wavelength infrared (3-8 um).

In some implementations, lateral chromatic aberration of the lens system is smaller than ten times (10×) the pixel pitch. In some instances, the lateral chromatic aberration of the lens system is smaller than five times (5×) the pixel pitch. In some instances, the lateral chromatic aberration is reduced to less than the pixel pitch (1×) of the image sensor. For implementations in which each of the lens systems includes a respective MOE (or DOE) lens, the operation bandwidth of the imaging system can, in some cases, be expanded by a factor 5-10 or even higher. The reduction in lateral aberration can be particularly advantageous in MOE- and DOE-based imaging systems in which the color aberrations tend to be relatively large compared to classic bulk refractive lenses.

In some implementations, the reduction of lateral color aberration can be targeted to values smaller than the smallest pixel sizes of some near-infrared CMOS image sensors (e.g., <1 μm). As a result, the operational bandwidth of such systems can be extended, in some cases, beyond the ±10 nm range (i.e., a full width at half maximum (FWHM) of 20 nm), and the modulation transfer function (MTF), or image quality, can still be quite high for all field angles even if a bandwidth of ±20 nm is used (i.e., a FWHM of 40 nm). In some implementations, lateral chromatic aberration of the lens system is less than 10 μm.

In some implementations, it may be desirable to use substrates 32, 36 having particular dimensions. For example, assuming the substrates 32, 36 are composed of glass and assuming a thickness t₁ for the first substrate 32, in some instances the second glass substrate 36 may have a thickness t₂ in a range between 0.8×t₁ to 2×t₁ to provide a desired reduction in lateral color shift at the image plane. In other implementations, the thickness t₂ may be in the range of 0.5×t₁ to 3×t₁, or in the range 0.3×t₁ to 5×t₁. In some implementations, it may be desirable to use lens systems such that the ratio of the products of the respective focal lengths (f₁, f₂) and the respective substrate thicknesses (t₁, t₂) before and after the stop aperture 16 are in the range of 0.5 to 2. That is:

$$0.5 < \frac{{f}_{1} * {t}_{1}}{{f}_{2} * {t}_{2}} < 2$$

In some implementations, the foregoing ratio may fall in the range of 0.3 to 5, or in the range of 0.2 to 10. Other ranges for the foregoing values may be appropriate in some cases.

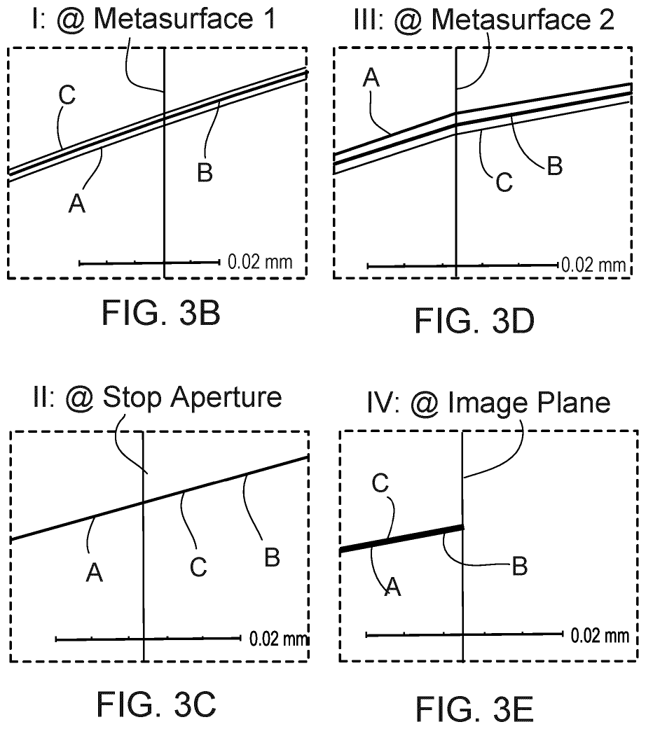

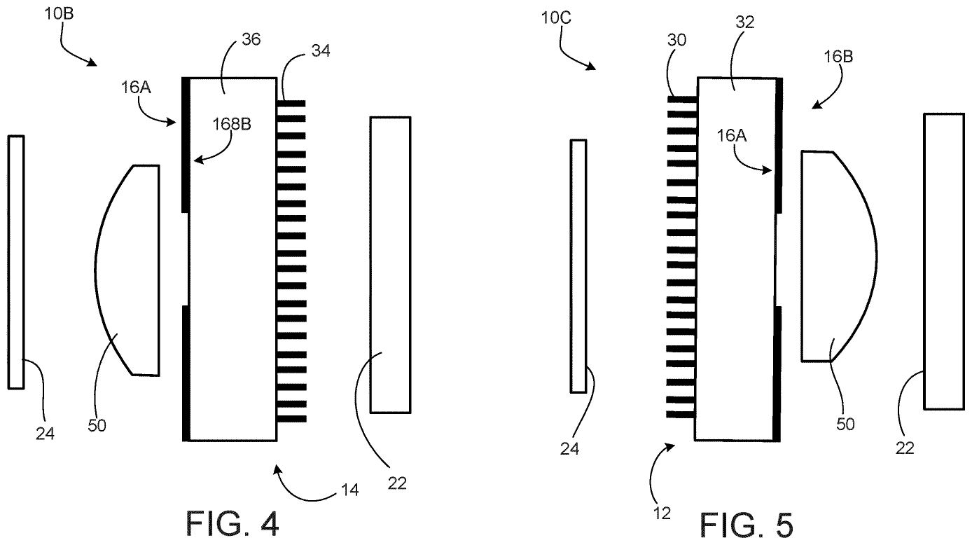

In some implementations, the MOE (or DOE) lens 12 or 14 in the first or second lens group can be replaced by a curved refractive lens composed, for example, of a bulk glass or plastic material. FIGS. 4 and 5 illustrate examples. In FIG. 4, the lens system 10B includes a curved refractive lens 50 instead of a front-side MOE (or DOE) lens. In FIG. 5, the lens system 10C includes a curved refractive lens 50 instead of a backside MOE (or DOE) lens. In some implementations, the lens groups may include other types of lenses (e.g., GRIN lenses, volume and surface holographic (HOE) lenses, or a combination of different types of lenses) instead of, or in addition to, the refractive lenses 50A, 50B.

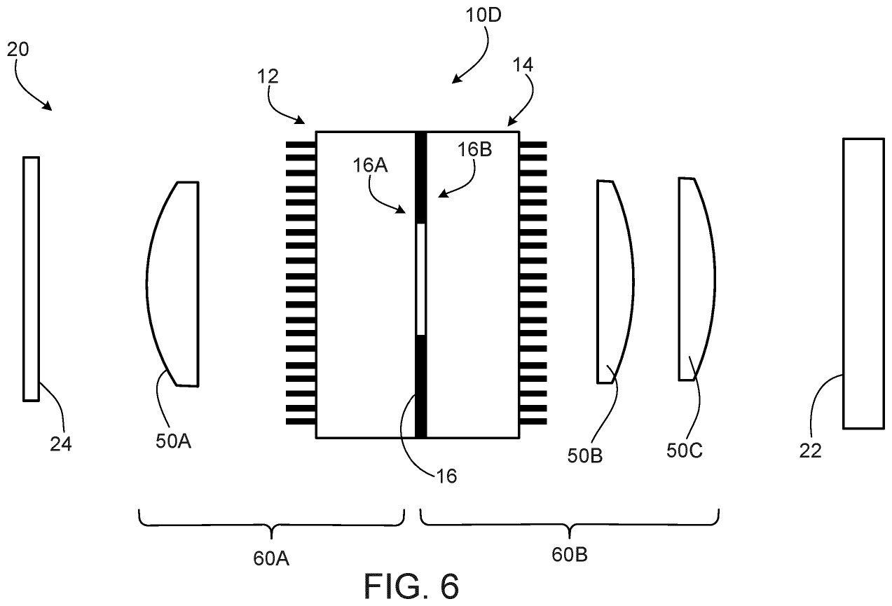

As mentioned above, and as illustrated in the example lens system 10D of FIG. 6, in some implementations there may be two or more respective lenses at one or both sides of the aperture stop 16. That is, in some instances, the front-side lens group 60A (i.e., the lens group closer to the front side 16A of the aperture stop) can include multiple lenses, which can be, for example, a combination of flat optics (one or more MOE and/or DOE lenses 12) and one or more other lenses 50A. Likewise, in some instances, the backside lens group 60B (i.e., the lens group closer to the backside 16B of the aperture stop) can include multiple lenses, which can be, for example, a combination of flat optics (one or more MOE and/or DOE lenses 14) and one or more other lenses 50B, 50C.

As with the other examples, the lens system 10D can be designed so as to compensate for lateral chromatic focal shift introduced by the lenses disposed at the object side and to balance out lateral color shifts. As an example, if the lens system has two lenses before the aperture stop, then in some instances the number of lens surfaces or lens elements after the aperture stop is in the range of one to five. Likewise, in some instances, if the lens system has three lenses before the aperture stop, then the number of lenses after the aperture stop is in the range of two to seven.

As noted above, lateral color aberration makes the magnification of the system wavelength dependent. Such wavelength dependency can result in focus blurring and broadening of the point spread function (PSF) which will result in a lower MTF and lower image quality. However, as the overall image quality typically depends also on other types of geometrical aberrations, optimizing the MTF need not require perfect symmetry of the lenses to achieve full cancellation of the lateral chromatic aberrations. That is, as illustrated in some of the examples described above, other geometrical aberrations also should be minimized at the same time the chromatic aberrations are addressed and, therefore, the architecture of the lens system may not need to be fully symmetric. For example, the one or more lenses facing the object (i.e., before the aperture stop) may have a weaker total power than the one or more lenses facing the sensor (i.e., after the aperture stop). Thus, in some instances, the effective focal length of the lens group before the aperture stop (i.e., closer to the object) can be longer than the effective focal length of the lens group after the aperture stop (i.e., closer to the sensor). Compensation of lateral chromatic aberration can still be accomplished by proper selection of lens parameters and distances between the lenses and the aperture stop.

While this specification contains many specifics, these should not be construed as limitations on the scope of the disclosure or of what may be claimed, but rather as descriptions of features specific to particular implementations. Certain features described in this specification in the context of separate implementations also may be combined in the same implementation. Conversely, various features described in the context of a single implementation also may be implemented in multiple implementations separately or in any suitable sub-combination. Various modifications can be made to the foregoing examples. Accordingly, other implementations also are within the scope of the claims.

1. An apparatus comprising:
a lens system including:
a first lens group;
a second lens group; and
an aperture stop disposed between the first and second lens groups,
wherein each of the first and second lens groups includes at least one respective lens, and
wherein at least one of the first or second lens groups includes at least one of a meta optical element (MOE) lens or a diffractive optical element (DOE) lens.

2. The apparatus of claim 1 wherein each of the first and second lens groups includes at least one of an MOE lens or a DOE lens.

3. The apparatus of claim 1 wherein each of the first and second lens groups includes a respective MOE lens.

4. The apparatus of claim 3 wherein each of the MOE lenses includes a respective metasurface on a respective substrate, and wherein there is a respective gap between the aperture stop and each of the substrates.

5. The apparatus of claim 3 wherein each of the MOE lenses includes a respective metasurface on a respective substrate, and wherein there is a gap between the aperture stop and at least one of the substrates.

6. The apparatus of claim 3 wherein each of the MOE lenses includes a respective metasurface on a respective substrate, and wherein respective backsides of the substrates are attached to another.

7. The apparatus of claim 1 wherein each of the first and second lens groups includes a respective DOE lens.

8. The apparatus of claim 1, wherein at least one of the first lens group or the second lens group includes a plurality of lenses.

9. The apparatus of claim 1, wherein a total power of the first lens group is different from a total power of the second lens group.

10. The apparatus of claim 1, wherein a total power of the first lens group is the same as a total power of the second lens group.

11. The apparatus of claim 1, wherein lateral chromatic aberration of the lens system is smaller than ten times an Airy disk radius for the lens system.

12. The apparatus of claim 1, further including one or more image sensors disposed to capture an image of an object based on light emitted by, or reflected from, the object and passing through the lens system.

13. The apparatus of claim 12 wherein the second lens group is closer to the one or more image sensors than is the first lens group, and wherein an equivalent power of the second lens group is greater than 25% of an equivalent power of the first lens group.

14. The apparatus of claim 12 wherein the second lens group is closer to the one or more image sensors than is the first lens group, and wherein a converging power of the second lens group is greater than 25% of a converging power of the first lens group.

15. The apparatus of claim 1, further including an image sensor disposed to capture an image of an object based on light emitted by, or reflected from, the object and passing through the lens system, wherein the image sensor has one or more pixel pitches, and wherein lateral chromatic aberration of the lens system is less than ten times the largest pixel pitch.

16. The apparatus of claim 1, wherein lateral chromatic aberration of the lens system is less than 10 μm.

17. A method comprising:
receiving, in a lens system, light emitted by or reflected from an object, wherein the lens system includes a first lens group, a second lens group, and an aperture stop disposed between the first and second lens groups, wherein each of the first and second lens groups includes at least one respective lens, and wherein at least one of the first or second lens groups includes at least one of a meta optical element (MOE) lens or a diffractive optical element (DOE) lens; and
capturing an image of the object in an image sensor based on the light emitted by or reflected from the object, the light having subsequently passed through the first lens group, the aperture stop, and the second lens group before impinging on the image sensor.

18. The method of claim 17 wherein the light emitted by or reflected from the object passes through the first lens group before passing through the second lens group, and wherein an equivalent power of the first lens group is smaller than an equivalent power of the second lens group.

19. The method of claim 17, wherein lateral chromatic aberration of the lens system is smaller than ten times an Airy disk radius for the lens system.

20. The method of claim 17, wherein the image sensor has one or more pixel pitches, and wherein lateral chromatic aberration of the lens system is less than ten times the largest pixel pitch.

21. The method of claim 1, wherein lateral chromatic aberration of the lens system is less than 10 μm.

22. The method of claim 1, wherein each of the first and second lens groups includes a respective MOE lens, and wherein the light emitted by or reflected from the object passes through the MOE lens of the first lens group before passing through the MOE lens of the second lens group.

23. A method comprising:
projecting, in a lens system, light emitted by or reflected from a light emitting or reflecting device, wherein the lens system includes a first lens group, a second lens group, and an aperture stop disposed between the first and second lens groups, wherein each of the first and second lens groups includes at least one respective lens, and wherein at least one of the first or second lens groups includes at least one of a meta optical element (MOE) lens or a diffractive optical element (DOE) lens.

24. The method of claim 23 wherein the light emitted by or reflected from the light emitting or reflecting device passes through the first lens group before passing through the second lens group, and wherein an equivalent power of the first lens group is larger than an equivalent power of the second lens group.

25. The method of claim 23, wherein each of the first and second lens groups includes a respective MOE lens, and wherein the light emitted by or reflected from the light emitting or reflecting device passes through the MOE lens of the first lens group before passing through the MOE lens of the second lens group.
